(19) United States
(12) Patent Application Publication
(10) Pub. No.: US 2026/0208311 A1
(43) Pub. Date: Jul. 23, 2026

(54) FLEXIBLE PROCESSING AND TOOLING SYSTEMS

(71) Applicant: Magna Exteriors Inc., Aurora (CA)

(72) Inventors: Daniel R. Vander Sluis, Rochester Hills, MI (US); Oliver Pace, Clarkston, MI (US); Hideki Yamamoto, Plymouth, MI (US); Brandon Halsey, North Baltimore, OH (US); Zdenek Severa, Troy, MI (US)

(21) Appl. No.: 19/448,900

(22) Filed: Jan. 14, 2026

Related U.S. Application Data
(60) Provisional application No. 63/819,255, filed on Jun. 6, 2025.
(60) Provisional application No. 63/746,741, filed on Jan. 17, 2025.

(51) Int. Cl. B23Q 15/22

(52) U.S. Cl. CPC B23Q 15/22

(57) ABSTRACT

A method of performing work on a part with one or more tools includes providing a part on a fixture within a workstation, where one or both of the location of the part on the fixture or the location of the fixture in the workstation is variable from one part to the next, and the part includes at least one position identification feature on a surface of the part. The method further includes determining a location of the part in the workstation with a position sensing device that detects the location and orientation of the at least one position identification feature, positioning a tool relative to the part as a function of the determined location of the part, and performing a work process on the part with the tool.

### REFERENCE TO RELATED APPLICATIONS

This application claims the benefit of U.S. Provisional Application Serial Nos. 63/819,255 filed on June 6, 2025 and 63/746,741 filed on January 17, 2025, the contents of which are incorporated herein by reference in their entireties.

### TECHNICAL FIELD

The present disclosure relates to flexible processing systems by which various work processes are performed on parts, and flexible tooling that may be used in the flexible processing systems.

### BACKGROUND

Production lines utilize custom fixtures made for a specific part being worked on in the production line. The custom fixtures are specifically machined and built to hold the specific part, and the part when retained by the fixture, is precisely located on the fixture. This enables a production run of parts to be repeatably and reliably positioned on the fixtures, and as the fixtures are moved through the production lines, the position of the parts can be known based on the location of the fixtures. Further, tooling at different workstations in the production line is fixed or dedicated to one work process such that parts are moved through various workstations when multiple work processes are needed to be performed on the part. That is, a tooling set up in one area of the production line performs a punching operation, by way of one example, but is not changeable to welding tooling to perform a weld on a part. Instead, the part is moved to a separate welding station at which separate tooling is set up to perform the weld.

Such production lines are not flexible, cannot accommodate differences in part location, perform limited processes with a single tooling setup, do not enable rapid tooling changes in a workstation, and do not accommodate parts of different designs. For parts of different designs, different fixtures are needed and different tooling is also needed for any different processes to be performed on the new/different parts in a production line. Thus, extensive customization of the fixtures and production lines are needed for different parts and different processes.

### SUMMARY

In at least some implementations, a method of performing work on a part with one or more tools includes providing a part on a fixture within a workstation, where one or both of the location of the part on the fixture or the location of the fixture in the workstation is variable from one part to the next, and the part includes at least one position identification feature on a surface of the part. The method further includes determining a location of the part in the workstation with a position sensing device that detects the location and orientation of the at least one position identification feature, positioning a tool relative to the part as a function of the determined location of the part, and performing a work process on the part with the tool.

In at least some implementations, the variability in one or both of the location of the part on the fixture or the location of the fixture in the workstation is greater than a maximum tolerance of the work process.

In at least some implementations, the at least one position identification feature includes at least one marking on a surface of the product.

In at least some implementations, the at least one position identification feature is defined by one or more scribe lines, or molded-in projections or cavities formed in the part.

In at least some implementations, the at least one position identification feature includes at least one location identifying feature by which the location of a specific portion of the part can be determined, and the at least one position identification feature includes at least one direction identifying feature by which an orientation of the part can be determined.

In at least some implementations, the tool is carried by a robot and the position sensing device is carried by the robot and is movable by the robot. In at least some implementations, the position sensing device is a camera, and the camera is carried by the robot so that a field of view of the camera includes at least a portion of the tool and an area in which the part is located. In at least some implementations, the tool is a first tool and the method also includes changing the tool to a second tool and performing a second work process on the part via the robot with the second tool. In at least some implementations, the first tool includes a first coupler that connects to an end effector of the robot, the second tool includes a second coupler that connects to an end effector of the robot, and the robot is adapted to automatically disconnect from the first tool and connect to the second tool to perform the second work process with the second tool.

In at least some implementations, the first tool and the second tool are part of separate C-frame assemblies, and changing the tool is accomplished by changing from a first C-frame assembly that includes the first tool to a second C-frame assembly that includes the second tool. In at least some implementations, the first tool and the second tool are part of separate tooling units that are releasably connected to a base, and changing the tool is accomplished by disconnecting from the base a first tooling unit that includes the first tool and connecting to the base a second tooling unit that includes the second tool.

In at least some implementations, a system by which one or more work processes are performed on a part includes a fixture having a support, a part received on the fixture engaging the support, the fixture permits the part to be located in different positions on the fixture, a robot having a connector and a vision sensor, and a tool coupled to the robot via the connector so that the tool is movable by the robot and a position of the tool can be determined with the vision sensor. The part includes at least one position identification feature by which a location and orientation of the part can be determined, and the vision sensor is arranged to determine the location and orientation of the position identification feature.

In at least some implementations, the system includes a second position sensing device that is arranged to enable determination of the position of the fixture and part within a workstation that includes the robot.

In at least some implementations, the location identifying feature includes a circle the center of which is located at the center of a location in which an opening is to be formed in the part, and wherein the orientation identifying feature includes a non-circular feature.

### BRIEF DESCRIPTION OF THE DRAWINGS

The following detailed description of preferred embodiments and best mode will be set forth with reference to the accompanying drawings, in which:

FIG. 1 is an illustration of an exemplary production cell, in accordance with the present invention;

FIG. 2 is an illustration of an exemplary production system with a plurality of automated stations, in accordance with the present invention;

FIG. 3 is an illustration of an exemplary production cell, in accordance with aspects of the present invention;

FIG. 4 is a perspective view of a hybrid punch/weld, according to aspects of the present invention;

FIG. 5 is a perspective view of a universal punch, in accordance with aspects of the present invention;

FIG. 6 is a perspective view of a modular C-frame, according to aspects of the present invention;

FIG. 7 is a side elevation view of FIG. 6 incorporating a modular punching frame, according to aspects of the present invention;

FIG. 8 is a side elevation view of FIG. 6 incorporating a modular welding frame, according to aspects of the present invention;

FIG. 9 is a perspective view of FIG. 8;

FIG. 10 is an enlarged perspective view taken at ‘A’ from FIG. 9.

FIG. 11 is a side elevation view of a modular C-frame of FIG. 6 incorporating a punch and die, according to aspects of the present invention;

FIG. 12 is a side elevation view of the modular C-frame of FIG. 6 incorporating a welder, according to aspects of the present invention;

FIG. 13 is a plan view of a portion of a part showing position identification features on the part;

FIG. 14 is a view of the part shown in FIG. 13 with a bracket attached;

FIG. 15 is a perspective view of a portion of an inner surface of a fascia with a bracket attached to the inner surface;

FIG. 16 is a side view of a tooling device including two tooling units removably coupled to a base of the tooling device at multiple points of connection;

FIG. 17 is a perspective view of part of a tooling device illustrating multiple points of connection between a tooling unit and a base of the tooling device;

FIG. 18 is a perspective view of part of a tooling device;

FIG. 19 is a perspective view of part of a tooling device;

FIG. 20 is a perspective view of part of a tooling device including a wireless transmission module; and

FIG. 21 is a side view of part of the tooling device of FIG. 20.

### DETAILED DESCRIPTION

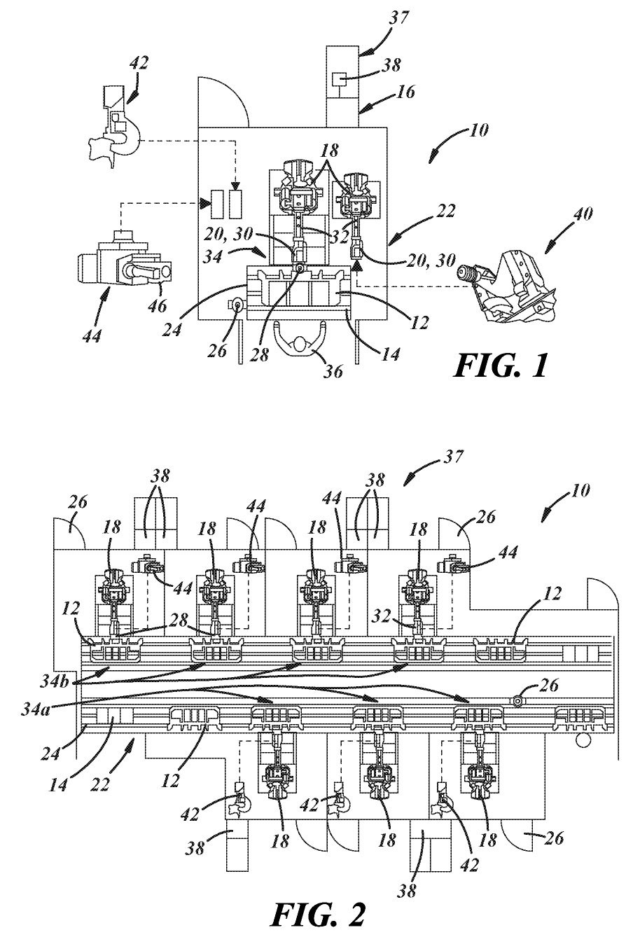

Referring in more detail to the drawings, FIGS. 1 and 2 show flexible part processing systems 10 that may be used in the manufacturing of vehicle parts 12. The processing system 10 may incorporate at least one fixture 14 that, in at least some implementations, is compatible and may be used to hold or position different parts 12 to be processed (i.e. have work performed on), at least one part position monitoring device 16, e.g., a vision system, at least one robot or machine 18, and at least one tool 20 by which work is performed on one or more parts 12 (e.g., a punching or welding tool) within an adaptable work area 22.

In at least some implementations, the fixture 14 may be used with multiple different parts 12 of different sizes and shapes, that is, a unique fixture is not provided for each different part 12 or type of part. With a common fixture 14 used with different parts 12, the location of parts 12 may vary from one part to the next within a production run of the same types of part, as well when different types of parts are being worked on. The parts can be arranged and located differently on the fixture 14 as the parts 12 are worked on in the processing system 10. In at least some implementations, the locations and/or orientations of parts may vary by an amount greater than a maximum tolerance of a work process being performed on the parts. Thus, the processes cannot be performed with fixed tooling that performs work in only a predetermined location, where that location does not change from part to part. Doing so would cause at least some work processes to be done outside of the areas of maximum tolerances.

To facilitate performing work on the differently located and/or oriented parts 12, the vision system 16 determines the position of a part 12 currently being worked on, and the robot 18 is equipped with one or more tools 20 by which one or more part processing operations are performed on a part 12 after the location and orientation of the part 12 are confirmed. It is understood that, by way of non-limiting example, the flexible fixture 14 may be of various constructions and arrangements, such as but not limited to those set forth in U.S. Patent Application Publication No. 2023/0047883, the entire content of which is incorporated herein by reference. The fixture 14 may be located on or be a portion of at least one advancing device 24 of system (e.g., cart, simplified fascia cart, cart with casters, rollers or wheels, belt, conveyor system, or any other device or arrangement suitable for selectively advancing the fixture as needed). An operator 36 is depicted adjacent the part fixture 14 (e.g., for loading and/or unloading the parts 12 relative to the fixture 14 and/or into the work station 34), however, it is understood that alternatively this step can be automated and performed by one or more suitably programmed or controlled robots.

As shown in FIG. 1, the processing system 10 may include at least one production cell or work area 22 in which various parts 12 may have worked performed on them, such as various machining or part processing operations that may include, by way of example and not limitation, milling, cutting, drilling, punching, grinding, sanding, joining parts, welding, adhering, riveting, coupling by fasteners or clips, and the like. Multiple processes can be performed on multiple different types of parts without having to have separate work areas 22 for various different parts being worked on. In at least some implementations, each work area 22 and/or work station 34 within a work area 22 is operably adaptable for accommodating a plurality of predetermined parts 12 of various shapes depending on the application, which significantly saves on production space, storage space, tooling costs, changeover (if any), and production downtime, as compared to needing dedicated areas and fixtures for each different type of part 12. While at least one workstation 34 is provided in a work area 22, it is understood that the flexible processing system 10 is adaptable depending on the application for increased part volumes with a plurality of work areas 22, robots 18 and workstations 34.

In at least some implementations, each work area 22 or workstation 34 includes one or more robots 18 equipped with desired tooling 20 to enable different work to be performed on a part 12, which may be a vehicle part, such as a front fascia, rear fascia, rocker panel, vehicle body panel, tailgate assembly, or any other part. Multiple parts 12 may be moved into and out of the work area on one or more fixtures 14, which may be non-dedicated fixtures as previously noted, and which may be carried on the advancing device(s) 24 into, within and out of the work area 22.

In at least some implementations, the vision system 16 may include a 1-layer or 2-layer system (or more), that may incorporate at least one artificial intelligence device or processor (e.g., three-dimensional (3D) vision, laser, 3D scanning, any suitable position technology, etc. and any combinations thereof) combined with at least one work area 22 (e.g., including at least one robot to perform one or more machining operations). For example, in at least some implementations, the system 10 may include at least one first position sensing device 26 that has a working area (e.g. the area in which the position of one or more things can be sensed by the device 26) that includes all or some portion of the work area 22 to enable determination of the location of one or both of a fixture 14 and part 12, and to facilitate movement of the robot 18 or portions of the robot 18 near and around the fixture 14 and part 12, and/or movement of the fixture 14 and part 12 relative to the robot 18 or work area 22. The first position sensing device 26 may be arranged to provide an overall view or “big picture” view of the work area 22 or part thereof (such as a workstation 34), and at least one part on a fixture (e.g., an overall fascia position on a fixture, in the example where the part 12 is a vehicle fascia). The first position sensing device 26 may include one or multiple sensors, and the one or multiple sensors may provide position sensing for different areas of the work area 22 and part(s) 12 in the work area 22, as desired. The flexible processing system 10 may include at least one first position sensing device 26 (e.g., first vision system) that, in at least some implementations, incorporates or is communicated with artificial intelligence (AI) processing capability.

Further, the robot 18 (or other robotic or machine mechanism) may incorporate at least one second position sensing device 28, such as at or near a hand or end effector 30 of a robot arm 32, where tooling 20 is carried by the end effector 30 and moved relative to the part 12 as work is performed on the part 12. The robot-based position sensing device(s) 28 can facilitate guiding movable portions of the robot 18 including the tooling 20 to the correct location and ensuring that desired work processes occur on the correct areas of parts 12. At least one second position sensing device 28 (which may be part of the vision system 16 or a second vision system) is also communicated with a controller or processor having AI processing capability, preferably as an AI vision system on the at least one robot 18 (e.g., on or near a grab hand or other end effector 30) and/or adjacent thereto (e.g., a final positioning vision system in at least one predetermined location on or adjacent to the robot 18).

The at least one robot 18 is preferably operable in at least two workstations 34 or positions within the work area 22 (e.g., to load/unload parts, and to perform punch and/or weld operations). At least one control system 37 including at least one programable controller 38 is provided for controlling the motion and operations of the at least one robot 18. The robot 18 preferably is one or more part-holding robots with a flex hand or end effector 30 (e.g., fascia holding robot with a flex hand). The at least one second vision system or second position sensing device 28 is preferably operably connected to and carried by the robot 18 near or with a view of an area that includes the end effector 30 and any tooling 20 connected to the end effector 30 to facilitate controlling the actions of the end effector 30 and for accurate position of the end effector 30 and tooling 20 relative to parts 12 being worked on. As an example, the robot 18 includes one or more robots with a clamp system 40 (FIG. 1), e.g., bean bag clamps with vacuum where parts are grabbed, and vacuum applied for additional holding and retention force.

The processing system 10 includes at least workstation 34 in which parts 12 are actively processed by the one or more robots 18. By way of one example, the workstation 34 may be a punch and weld station in which both a punching operation and a welding operation may be performed. In this example, the workstation 34 includes a robot 18 with an end effector 30 that carries at least one punch and die tooling device 42, which may include a C-frame to which is mounted the punch and die tools 20. Further, in this example, the same robot 18 can connect the same or a different end effector 30 to a sonic welding tooling device 44, which may include at least one sonic welding tool 20 (e.g. a weld horn) and at least one bracket holding jig 46 (FIG. 1) by which a bracket is held and welded to a part 12 in the workstation 34. While punching and welding operations and related tooling devices 42, 44 are described with regard to the workstation 34 and the robot 18 therein, different operations can be performed, and more than one robot 18 may be used to perform the different operations, as desired.

Referring to FIG. 2, wherein like numbers indicate like parts described in greater detail previously and incorporated herein, there is depicted a flexible processing system 10 incorporating a plurality of processing workstations 34 and, with each workstation 34 including at least one robot 18. The system 10 includes at least one advancing device or system 24 (e.g., at least one conveyor) to advance a plurality of the flexible, not part specific fixtures 14 from workstation 34 to workstation 34. While a substantially parallel advancing system 24 is depicted, it is understood that any configuration is contemplated depending on the application. The advancing system 24 may include a conveyor belt on which each fixture 14 is placed. A robot 18 or an operator 36 loads at least one part 12, preferably multiple parts 12, on each fixture 14 which may include supports on which the parts 12 are positioned.

In at least some implementations, multiple first workstations 34a are provided. Each first workstation 34a may be arranged to perform a predetermined process at one or more predetermined locations on each part, the processes and locations may vary on a given part or among different parts. In the example shown in FIG. 2, multiple first workstations 34a are arranged to perform a first process, such as, punching an aperture in the parts 12. At least one robot 18 in each workstation 34a includes a punch and die tooling device 42 for punching at least one aperture in a predetermined location in each part 12. At least one first position sensing device 26, and at least one second position sensing device 28, is provided in each workstation 34 (for clarity of other features in the drawing, some of the part position sensing devices are omitted in some of the workstations 34). The position of each part 12 within a cell/workstation 34 and/or with respect to its associated fixture 14 may be determined by one or both sensing devices 26, 28, and then the robot 18 may be actuated to, with the punch and die tooling device 42, punch an aperture in each part 12 in a desired location on the part and as a function of the actual position of each part on its associated fixture 14.

As also shown in FIG. 2, multiple second workstations 34b are provided for performing a second predetermined process on each part 12, such as welding which may include sonic welding. Each second workstation 34b may include one or more position sensing devices 26, 28, and at least one robot 18 in each second workstation 34b is equipped with a welding tooling device 44. In this example, at least one sonic weld is provided on each part 12 after the position of the part 12 is determined. Thus, at each workstation 34a, 34b one or more predetermined processes are performed at predetermined locations on the parts 12. It is understood that more or fewer first and second workstations 34a, 34b may be provided, and that the number and configuration of first workstations 34a and second workstations 34b are adaptable depending on, for example, space, the predetermined processes to be performed, and production demand.

By utilizing robots 18 at each workstation 34 combined with part position sensing devices 26, 28 and associated vision and control systems (such as vision system(s), lidar(s), laser(s), scanner(s), 3D vision, 3D scanner(s), etc., and any combinations thereof), that may incorporate artificial intelligence processing to improve positions determinations for a wide range of different parts 12, quality requirements can be achieved across a wide range of parts and different work processes, with non-part specific nests or fixtures 14 (e.g., non-CNC cut nests that are flexible part fixtures). The non-CNC cut nests accept a plurality of different parts of different shapes, and the flexible processing system 10 enables punching and welding processes (or other predetermined processes) on the same production volume setup or with minimum changeover.

Referring to FIGS. 1 and 2, in at least some implementations, the flexible processing system 10 incorporates at least one of the following and any combinations thereof: at least one production workstation 34 having at least one robot 18 with punching and/or sonic welding tooling 42, 44; at least one flexible part fixture 14 (e.g., fascia nest) that is not part specific; and at least one vision system 16 or work area scanner to find part positions (e.g.,1-layer AI or 2-layer AI or at least two layer AI).

The processing system 10 can be less complex and utilize less expensive fixtures 14 that can be used with various products, instead of part specific fixtures that are useful for only one product. The processing system 10 also may utilize machines that are not solely dedicated to a particular product or process (e.g., designed for only one fascia model or to perform only punching). Predetermined program specific castle horns, needles, welding tip, etc., can be operably changed out (e.g., even automated where a robot 18 automatically changes tooling 20 without human intervention, as described in more detail later) rather than requiring dedicated robots/machinery where the entire dedicated unused robot/machine sits idle and needs to be swapped out and put into use for other products (e.g., swapped for manufacturing other products when the robot may just need to change a welding tip). In at least some implementations, multiple different welding tips or tool parts can be pre-loaded to avoid downtime and the need to change out welding tips or tools, or robots as was previously required by conventional systems.

The processing system 10 is operable to achieve production capable speeds (e.g., advancing parts to process-dictated stations), provides flexible fixturing and tooling reduction (e.g., utilizing a highly flexible tooling with various different shaped parts), allows process position repeatability and necessary flexible nesting support as needed (e.g., part position locating processed by a robot). This allows program-specific tooling reduction in that a common fixture (e.g., such as a reindeer fixture,-bar support, etc.) can be used for multiple different parts or production programs. Further, the system can include position sensing within a 3D vision system/scanner, at least part of which may be carried on the robot, to enable accurate determination of the location of each part within a production run of parts. Previously, parts were fixed in an exact location on part-specific fixtures such that the location of each part was known by virtue of it being connected in an exact location on the part-specific fixture, and only routine position sensing was needed to ensure the fixture was in the correct location within a workstation – variability in part position was not permitted prior to work being performed.

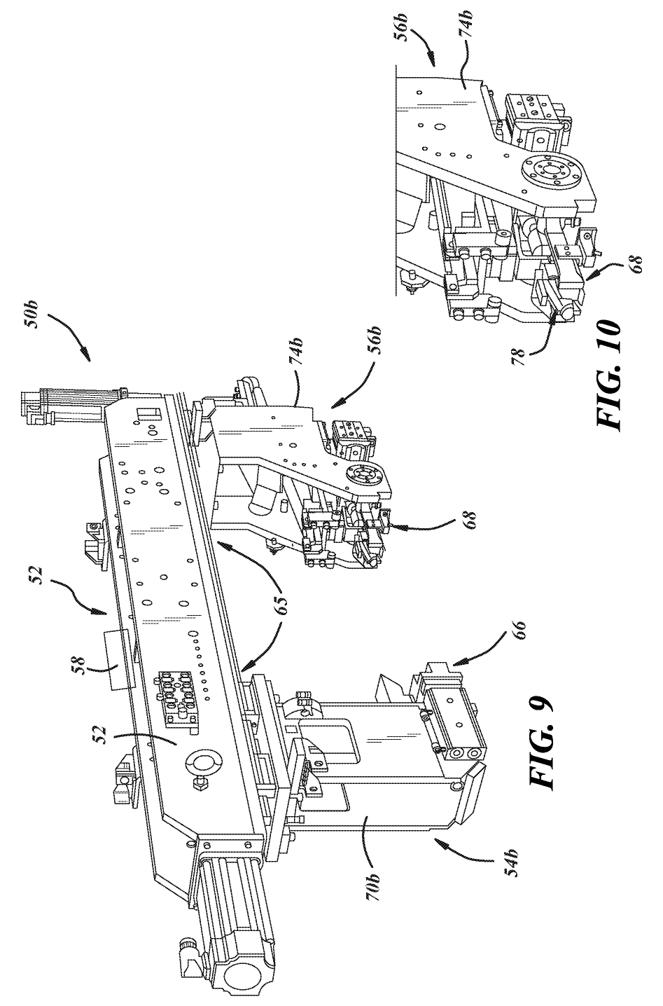

FIGS. 6-12 illustrate various modular tooling devices 50 that enable further flexible processing to be performed within a workstation 34, and which may be used as described with regard to the punch tooling devices 42 and weld tooling devices 44 already described, or with other tooling and for other processes. In at least some implementations, the modular tooling device 50 may define a so-called a C-frame tooling device with a base 52 and modular first and second tooling units 54, 56 that are removable or interchangeably coupled to the base 52. That is, different tooling units 54, 56 with different tooling 20, can be connected to and used with the same base 52. Tooling units 54, 56 may be swapped out to provide additional tooling for the same work process (e.g. a new weld tooling unit may include new weld tips) or for a different work process (e.g. changing a device from a welding device to a punching device by swapping out the weld tooling from the base with tooling for punching). While both of the first and second tooling units 54, 56, may be swapped out in some implementations, in at least some implementations, a first tooling unit 54 may be useable with different second tooling units 56 (or vice versa) such that only one tooling unit needs to be swapped out for at least some work processes.

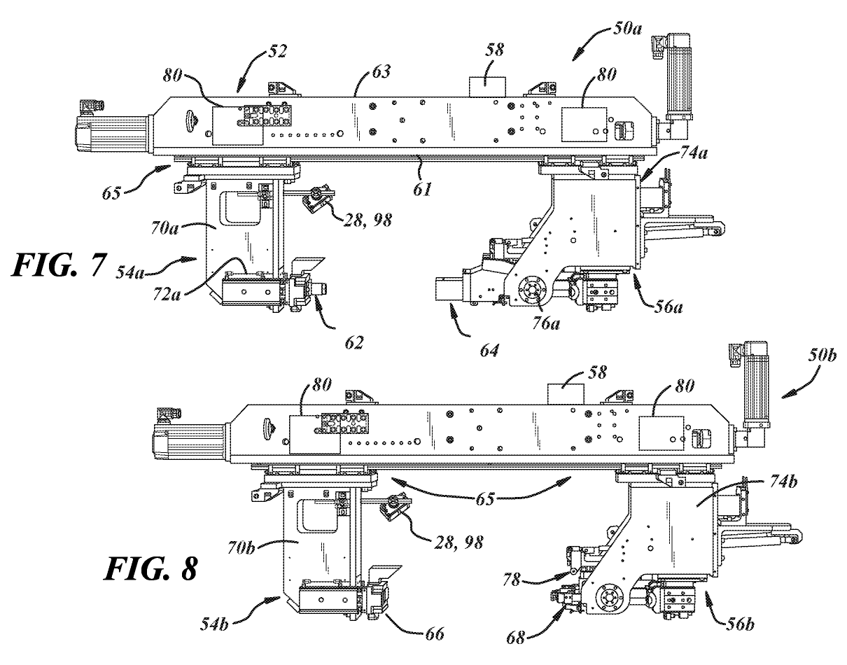

Referring to FIG. 6, the base 52, in at least some implementations, can be a rigid, straight body having a longitudinal length between opposite ends 53, 55, a lateral width between opposite sides 57, 59, and a height between opposite first and second surfaces 61, 63 that extend longitudinally and laterally. The first surface 61 includes a mounting interface 65 for the tooling units. The mounting interface 65 may include, for example, longitudinal rails or slots or other features that may define a track or tracks. The tooling units 54, 56 can be moved along the mounting interface 65 and either fixed in desired longitudinal locations on the base 52, or the tooling units may be slidable on the base in use, such as by being driven for linear movement by one or more actuators. The base 52 also includes at least one coupler 58, shown as being fixed to the second surface 63, that is operable to selectively couple to and be carried by a robot 18 (e.g., see FIG. 2), such that the tooling device 50 defines or is carried by an end effector 30 or connector of the robot 18. The coupler 58 is a mechanical coupling including hardware operable to interconnect with a corresponding coupler 60 of the robot 18 allowing easy removal/swapping to other tooling devices 50. For example, a robot 18 can switch entire tooling devices 50, such as between a modular tooling device 50a, shown in FIGS. 6 and 7 (the tooling device 50a) holding tooling units 54a, 56a including a punch 62 and die 64, and a modular tooling device 50b, shown in FIGS. 8-10, holding tooling units 54b, 56b including a back plate 66 and welder 68. So arranged, the robot 18 can be coupled to entirely different tooling devices 50 via the respective couplers 58 of the tooling devices 50. In this description, for ease of description, reference numeral 50 is intended to be generic/inclusive of devices 50a and 50b, and other such devices, and other features of the devices 50, such as the tooling units 54, 56 may also be referred to inclusively without use of letters indicating different versions. Further, the robot 18 may be configured to automatically couple to and decouple from the tooling devices 50 without human involvement in the changing of tooling devices used by the robot.

In addition to or instead of swapping entire tooling devices 50, the individual tooling units 54, 56 can be selectively coupled to and decoupled from a base 52 that remains connected to the robot 18. In this way, a common base 52 can be used with different tooling units 54, 56 to enable different work processes to be performed by the robot 18, without swapping out entire tooling devices 50, and fewer bases 50 and tooling parts may be needed at a work station 34. The base 52 can be considered to be universal in that it can be used with different tooling units 54, 56 and used in different work processes. Similarly, different bases 52 (e.g. one larger than the other) can have similar mounting arrangements for different tooling units 54, 56 such that tooling units 54, 56 can also be used with different bases thereby increasing the utility of the individual tooling units 54, 56. The tooling units 54, 56 can also be considered to be universal in the sense that the same tooling unit can be used on different bases (where the different bases could be of the exact same or different construction).

A first mode of the modular tooling device 50a, as shown in FIG. 7, is set up with a predetermined modular punching arrangement. The first tooling unit 54a of this device 50a includes first support member 70a connected to or including an attachment feature 72a to which the punch 62 is operably connected. One end of the support member 70a of the first tooling unit 54a is operably connected to the base 52 at the mounting interface 65. In the example shown, the first tooling unit 54a is cantilevered from and extends vertically away from the base 52, with the punch 62 oriented facing the opposite end of the base 52 from which the first tooling unit 54a is nearest. The first tooling unit 54a may be fixed to the base 52 in a single location, or the first tooling unit 54a may be movable relative to the base 52, such as by a suitable interface between the support member 70a and the base and along which the support member 70a may slide (e.g. as a carriage or shuttle). The first tooling unit 54a may move relative to the base 52 in performing a work process (e.g. punching an aperture in this example), or the first tooling unit 54a may be moved to a desired location on the base 52 and then fixed in position, with the punch 62 being driven relative to the support member 70a and base 52 during a stroke of the punch 62.

Additionally, in the first mode, the second tooling unit 56a includes a modular second support member 74a with an attachment feature 76a operably connected to the die 64 of the punch tooling set. One end of the second support member 74a is operably connected to the base 52 at the mounting interface 65. In the example shown, the second tooling unit 56a is cantilevered from and extends vertically away from the base 52, with the die 64 oriented facing the opposite end of the base 52 from which the second tooling unit 56a is nearest, so that the die 64 is aligned with and opposed to the punch 62. So arranged, the tooling device 20 including the base 52 and tooling units 54a, 56a is generally C-shaped. The second tooling unit 56a may be fixed to the base 52 in a single location, or the second tooling unit 56a may be movable relative to the base 52, such as by a suitable interface between the second support member 74a and the base (e.g keyway or track) of along which the support member may slide (e.g. as a carriage or shuttle). The mounting arrangement of the second support member 74a may be the same as that for the first support member 70a, if desired. The second tooling unit 56a may move relative to the base 52 in performing a work process (e.g. punching an aperture in this example), or the second tooling unit 56a may be moved to a desired location on the base 52 and then fixed in position, and the die 64 may be movable relative to the second support member 74a in at least some implementations.

Either or both the first tooling unit 54 and the second tooling unit 56 may be driven, e.g. slidably, along the modular base 52 by one or more motors or other actuators 80 (e.g. pneumatic or hydraulic), providing a single direction or dual direction stroke, when needed. Further, the ends of the mounting interface may be open such that the tooling units 54, 56 can be connected to the base 52 by sliding the tooling units over the open ends and onto of the longitudinally extending features that define the track or other mounting interface. And the tooling units 54, 56 can be disconnected from the base 52 by sliding the tooling units in the opposite direction until they pass the ends of the mounting interface 65. In other arrangements, the tooling units can have movable mounting features that enable the tooling units to be coupled to the mounting interface without sliding the tooling units over an end of the track/mounting interface.

Thus, the modular punch tooling device 50a provides punch and die tools 62, 64 that may be releasably coupled to the base 52, and/or wherein the base 52, to which the punch and die tools 62, 64 are connected, may be releasably connected to a robot 18 so that the robot 18 can connect to a different base 52 having a different tooling device 50 to perform a different work process. In at least some implementations, as shown by comparison of FIGS. 7 and 8, the punch tool 62 is movably or removably connected to the support member 70a and is selectively movable or removed to expose a welding back plate 66, such that the first tooling unit 54a can be converted between providing the punch 62 or back plate 66 without changing out the first tooling unit 54a.

In a second mode of the tooling device 50b, as shown in FIGS. 8-10, a predetermined modular welding arrangement is provided. In this example, the first tooling unit 54a is either swapped out for a different first tooling unit 54b with a weld back plate 66, or the punch 62 removed from the attachment feature of the first tooling unit 54a, or retracted into the first tooling unit 54a or otherwise moved out of the way, thereby exposing a welding back plate 66 already incorporated into the first tooling unit 54a. Additionally, in the second mode, the second tooling unit 56a is replaced with a second tooling unit 56b including the welder 68 which may optionally include a holder 78 for a part being welded (e.g. a bracket). Or, the welder 68 is connected to the second support member 74a at its attachment feature 76a to convert the second tooling unit 56a for a welding operation. Thus, the tooling units can be swapped out, or tools carried by the tooling units can be swapped out or converted to other tools, providing the ability to quickly and easily change the function of tooling devices, and to enable tooling devices to include a range of tools.

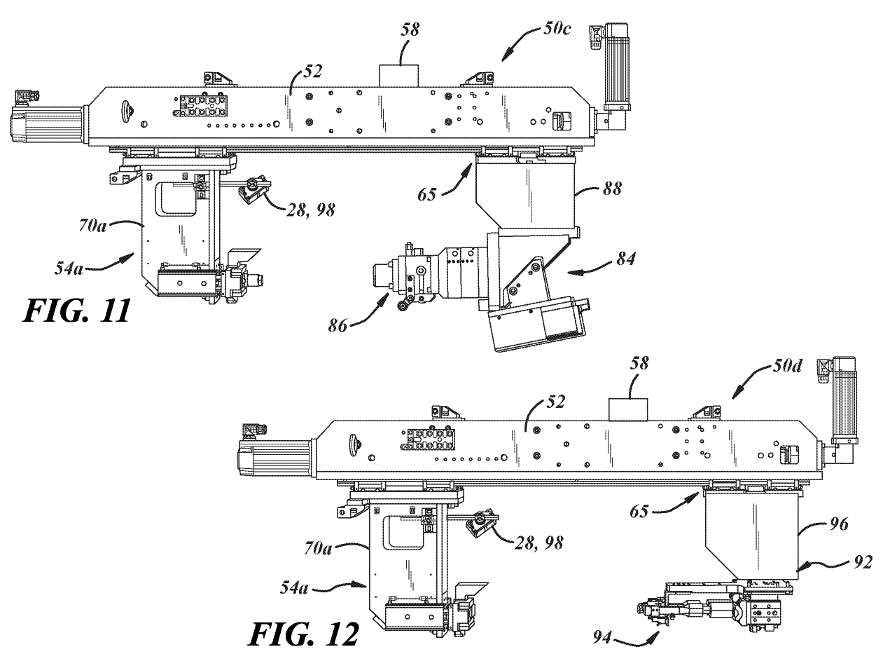

FIG. 11 substantially incorporates like features of FIGS. 6 and 7 and further depicts a tooling device 50c having an alternative second tooling unit 84 with a die portion 86 operably connected to the second support member 88 of the second tooling unit 84. In this example, the entire second tooling unit 84 is designed to be removed from the base 52, as needed, and the first tooling unit 54a may be the same as described earlier or it may also be designed to be entirely removed when a different tool is needed.

Similarly, FIG. 12 substantially incorporates like features of FIGS. 8-10, and further depicts a tooling device 50d having an alternative second tooling unit 92 with a welder and bracket holder 94 operably connected to a second support member 96 of the second tooling unit 92. In this example, the entire second tooling unit 92 is designed to be removed from the base 52, as needed, and the first tooling unit 54b may be the same as described earlier or it may also be designed to be entirely removed when a different tool is needed.

While punch and weld tooling devices are depicted in FIGS. 6-12 and have been described, it is understood that any other tooling may be incorporated on a base 52 or in a tooling device 50a, 50b, 50c, 50d (hereafter referred to with only reference numeral 50 for ease of description) depending on the application and work process to be performed. Further, as shown in FIGS. 7, 8, 11 and 12, at least one camera 98 (or other second position sensor 28) may be provided on the tooling devices 50, and the cameras 98 may be connected to the base 52 and/or tooling units 54, 56, as desired. The cameras 98 may define the second position sensing devices 28 described herein, and part of the vision system 16 generally, that is used to determine part locations and to enable guidance of the tooling devices 50 to a desired location on each part. The cameras 98 or other position sensing devices 28 may be coupled to a controller or control system 37 including multiple controllers or processors, and enable a robot 18 to automatically (e.g. without human involvement) disconnect from and connect to bases 52 of different tooling devices, and or to swap out different tooling units 54, 56 from a base 52 of a tooling device 50. Such tooling changes can also be made with human involvement by an operator who connects desired tooling to a robot 18, if desired.

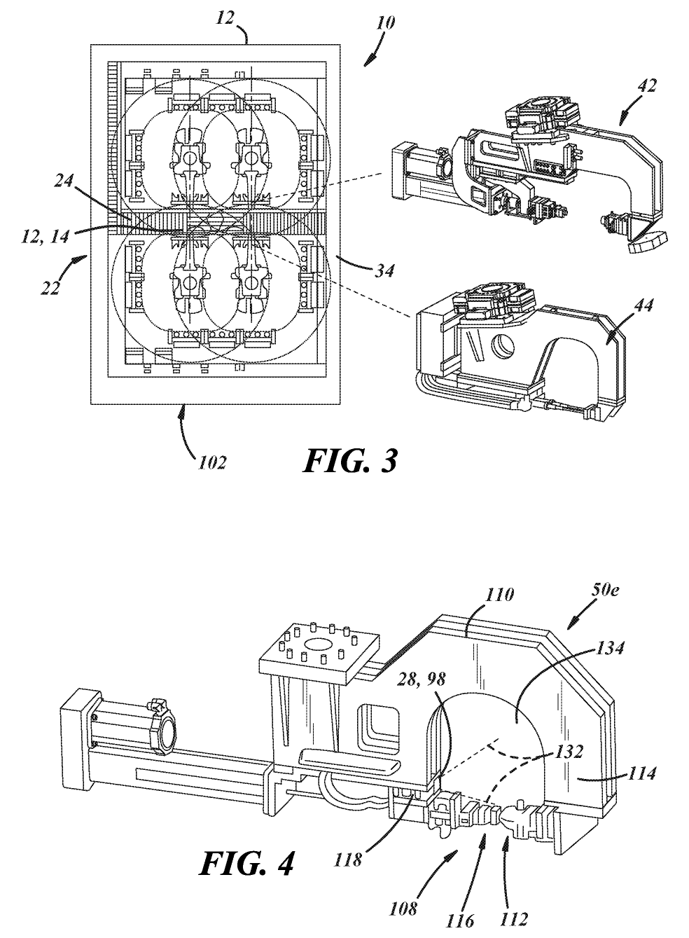

Referring now to FIG. 3, there is depicted an exemplary production workstation 34, that incorporates at least one robot 18, at least one conveyor 24, at least one fascia pallet (which may be considered to be a fixture 14), and at least one tool rack 102. The tool rack 102 can retain multiple different tools 20 (which may include modular tooling devices 50) and/or multiple different tooling units 54, 56, for coupling to one or more bases 52 to define different tooling devices 50, as set forth herein. In some implementations, at least two robots 18, and in some implementations, at least two pairs of robots, are provided with the conveyor 24 located between the robots 18 and operable for transporting parts 12 relative to the robots 18.

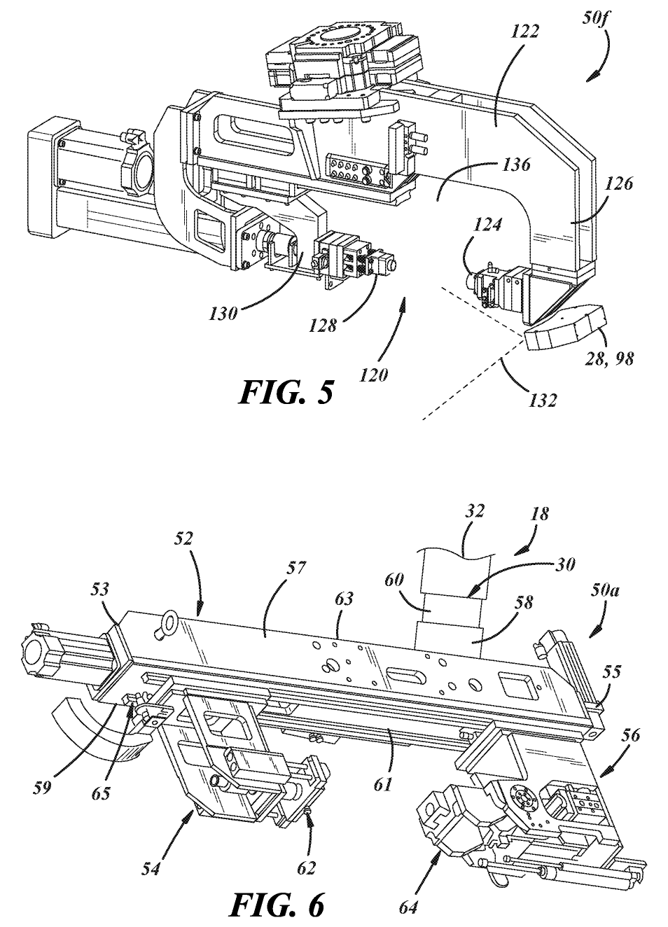

FIGS. 4 and 5 show still further implementations of tooling devices 50e, 50f. In FIG. 4, the tooling device 50e includes weld tooling 108 that, in at least some implementations, is not adapted to be readily swappable off or removable from the base 110 of the first tooling device 50e. In at least some implementations, the weld backing portion 112 of the weld tooling 108 is fixed to a first support 114 that is fixed to and extends from and may be integral to the base 110. The welder 116 of the weld tooling 108 is carried by a second support 118 that is coupled to and slidably or linearly movable relative to the base 110, to enable the welder 116 to move through a stroke relative to the weld backing portion 112 during a welding process.

As shown in FIG. 5, the tooling device 50f includes punch tooling 120 that, in at least some implementations, is not adapted to be readily swappable off or removable from the base 122 of the second tooling device 50f. In at least some implementations, the die portion 124 of the punch tooling 120 is fixed to a first support 126 that is fixed to, extends from and may be integral to the base 122. The punch portion 128 of the punch tooling 120 is carried by a second support 130 that is coupled to and slidably or linearly movable relative to the base 122, to enable the punch portion 128 to move through a stroke relative to the die portion 124 during a punching process.

To change from punching to welding, the robot 18 could disengage from the base 110 of the first tooling device 50e and couple with the base 122 of the second tooling device 50f. In this example, the tool rack 102 would include a selection of tooling devices (e.g. 50e, 50f and others) having any desired tooling and to which the robot 18 may selectively be connected via the robot coupler 60 and couplers 58 on the bases 110, 122 as previously described. In this way, a robot 18 can perform multiple different operations with multiple different tooling devices, as desired.

As before, suitable cameras 98 or other position sensing devices 28 may be associated with the tooling devices, and may have a working or sensing area (e.g. a field of view of a camera) that includes at least a portion of the tooling and a relevant portion of a part to be worked on. Swapping of tooling devices may be done automatically by the robot, as guided by one or more position sensing devices, or by a person, as desired. As shown in FIGS. 4 and 5, the tooling devices 50e, 50f may include position sensing devices 28 used by the vision system 16 to determine one or both of part location and tooling location. A field of view of the sensing devices is illustrated within dashed lines at 132 and may include a working end of the tooling (e.g. the end that engages a part) and an area adjacent to the working end of the tooling. The sensing devices 28 may be arranged in different locations depending, for example, on the type of tooling included on a tooling device. In FIG. 4, the sensing device 28 is shown as located between part of the base 110 and the tooling 108, in a window or open area 134 of a C-frame portion of the base 110. In FIG. 5, the sensing device 28 is shown as located on an outer side of the base 122, outboard of the C-frame window 136 and adjacent to an outer side of the tooling 120 and not between the tooling 120 and the C-frame base 122.

The flexible processing systems are configurable and useable in a production line or work area 22 to perform different work process that may be performed on a multitude of different parts 12, in a three-dimensional space and even when the parts are not held in an exact location by part-specific fixtures and are instead received in or on non-dedicated fixtures 14 via which some part to part position changes can exist. The flexible processing systems utilize one or more position sensors and a vision system to determine the location of each part and to ensure that work is performed on desired areas of each part.

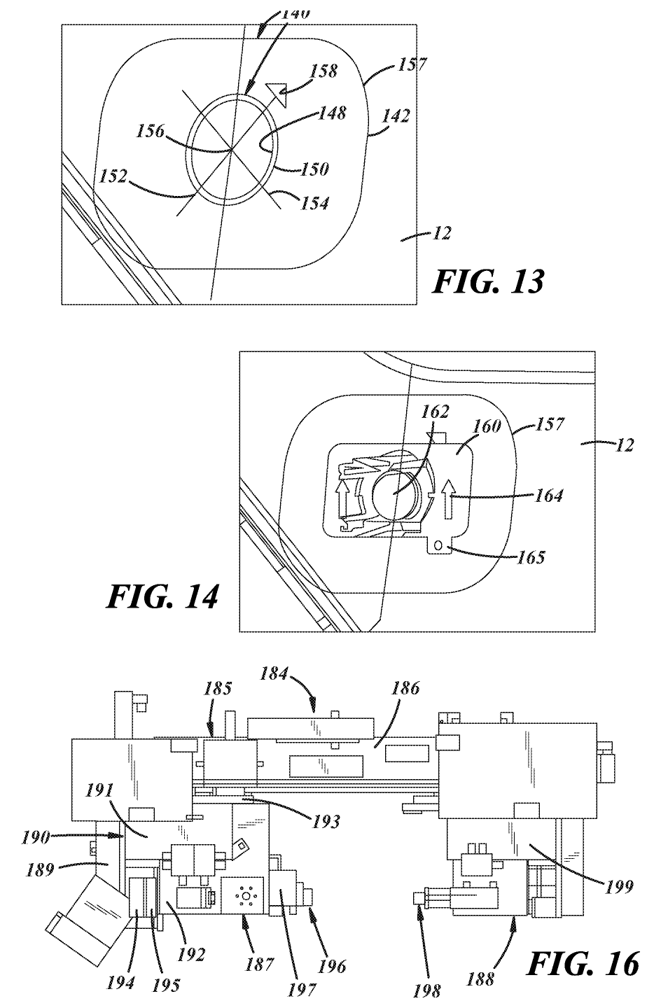

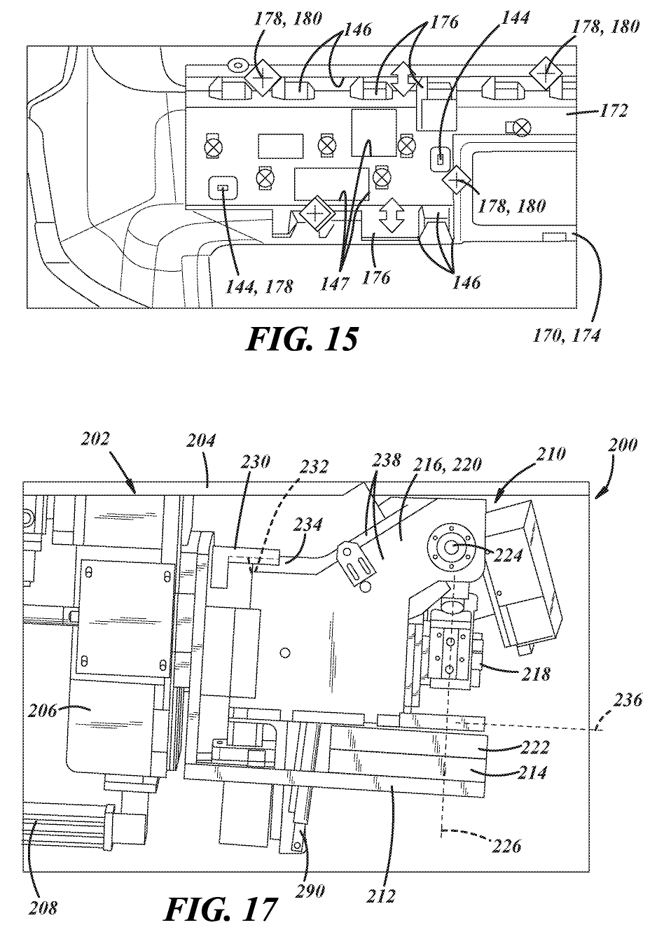

Referring generally to FIGS. 13-15, to facilitate determination of part position and areas of the part 12 on which work is to be performed, the parts 12 can include one or more position identification features 140 that are applied to or formed integrally with the part 12 when the part is formed. For example, the part 12 may include one or more scribe lines 142 which may be cavities or projections on a part surface, define one or more position identification features 140 and is/are shaped and oriented to define a specific location and orientation of the part 12. The cavity or cavities and projection(s) 142 could be formed in the part when the part is molded, in the case of a molded part, can have different heights, lengths and shapes, or the features can be defined by components attached to the part 12 after the part is formed, or features of the part itself that also serve a different function (e.g. as shown in FIG. 15 , one or more flanges 144 that define part of a snap-fit connector, or one or more ribs/supports that provide structural rigidity to the part 12, or edges of openings 147, and also permit determination of part location and orientation).

In at least some implementations, the identification features 140 could include surface indicia or markings that are drawn or painted on, or features/shapes burned or etched in (e.g. by laser or cutting tool) a part surface, or otherwise provided on a surface of the part 12 so as to be distinguishable from other portions of the part 12 and to enable determination of the location of such features 140 by the position sensors 26, 28 and vision system. In this way, rather than having a part-specific fixture retain a part in an exact position relative to the part and have the fixture in an exact location within a workstation in order to know the location of a part, the part itself includes its own datum points. Thus, even if the part is not located exactly the same as previously worked on parts, the system can positively determine the location of the part and perform accurate work on the part. That is, by determining the location and orientation of one or more position identification features 140, the vision system 16 and control system 100 can determine the location and orientation of the part including, in at least some implementations, areas of the part that do not include position identification features 140.

FIG. 13 illustrates an arrangement of position identification features 140 on the surface of a part, either as markings/scribe lines or as molded-in projections (e.g. ridges) or cavities. The position identification features 140 as shown include an inner circle 148, an outer circle 150 concentric with and larger than the inner circle 148, two transverse lines 152, 154 that intersect at a center 156 of the circles 148, 150, and an outer rounded rectangle 157. The transverse lines 152, 154 extend radially beyond and outward of the circles 148, 150, and one of the transverse line 152 includes a triangle or arrow head 158 at an end of the line 152, which may also be located radially outward of the circles 148, 150. The circles 148, 150, and particularly the center 156 thereof, may identify a specific spot/specific location on the part 12. The inner circle 148, in at least some implementations, may define a size and location for an aperture to be formed (in a punching example). The transverse line 152 including the triangle or arrow head 158 or other non-circular shape or feature, provides a directional identification to facilitate determining an orientation of the part 12 (e.g. if a part is rotated slightly on the fixture).

So, in at least some implementations, the identification features 140 include at least one location identifying feature (represented by the center 156 of the circles 148, 150 in the above example, but which could be any desired feature) by which the location of a specific portion of the part can be determined, and at least one direction identifying feature (represented by the line 152 and arrow head 158 in the above example, but which could be any desired feature) by which the orientation of the part 12 relative to the fixture or work area 22 can be determined. In this way, not only can the location of a spot of interest on the part be determined, but also the orientation of the part itself (i.e. if one part is positioned on the fixture slightly rotated or out of position relative to other parts, the location and orientation of that part could both be different and suitable adjustments would then be needed to where the robotic controlled work operation is performed).

FIG. 14 illustrates a bracket 160 (or other second part) connected to the part 12 after an aperture 162 has been formed in the part 12, and as shown, the bracket 160 or second part, can also have position identification features 164, shown in this example as an arrow formed on the back side of the part 12 and/or a depending tab 165 formed in the bracket 160 and extending off an edge of the bracket 160. The second part’s identification features 164, 165 can be recognized by the vision system 16 via a position sensing device 26, 28 to ensure that the second part 160 is properly oriented before being coupled to the first part 12. With the robot 18 and vision system 16, this can all be done automatically, without human intervention, in at least some implementations.

If a simple, circular hole is to be punched that is centered with the circles 148, 150, the direction identification might not be needed. But, in the example of connecting a bracket to the part, where the orientation of the bracket matters, the direction identification ensures that the bracket can be located as desired and oriented as desired before being connected to the part. Likewise, many machining or work process (like welding, forming a non-circular shape, adhering, etc) are directional, such that not only the location of where to start a process is important but the orientation of the part 12 is important to ensure the work process proceeds to the correct portions of the part 12. With the datum point or points provided on the part itself, the work process location can be adjusted to suit the location of each part in the cell or workstation, where the location of each part might be different than other parts due, for example, to use of fixtures that are not part specific and do not perfectly position each part.

A single position identification feature 140 may be sufficient to inform the system as to the location and orientation of the entire part 12 and form the basis for different work processes formed on different areas of the part. Or, in other implementations, multiple location position identification features 140 can be provided, and in at least some implementations, at least one position identification feature 140 is provided in the area of each work process to be performed, where a single part may have multiple work processes performed on it, to connect multiple brackets, punch multiple apertures, weld different areas, and the like. While circles and straight lines are shown as possible position identification features, the range of possible position identification features is not so limited. The features 140 may be indicia applied to the part of any desired shape and orientation, and the features may also or instead be defined by structural features or surfaces of a part, such as but not limited to, support ribs or flanges, edges of the part or a feature of the part (e.g. an edge of a rib or aperture in the part). The various position identification features may provide a map for the various work processes to be performed on a part, where each process is performed in an open space and relative to the actual location of individual parts within the workstation.

FIG. 15 illustrates two parts 170, 172 coupled together by the flexible processing system. The first part 170 defines part of a vehicle component the outer surface of which defines part of an exterior of the vehicle. The second part 172 is a bracket coupled to an inner surface 174 of the first part 170. One or both parts 170, 172 may have one or more molded-in features that define position identification features 140 by which the location and orientation of both parts 170, 172 can be determined. Further, one or more molded-in features 176 may be used to enable or improve gripping or holding of at least the second part 172 by a robot end effector, for locating the part 172 prior to work being performed and/or during performance of work on the parts. The second part 172 may have multiple locating features 178 that may receive or abut complementary locating features 180 on the first part 170 (complementary pegs and cavities, or snap-fit flanges and slots, etc), to initially stage and retain the second part 172 relative to the first part 170. The robot end effector may engage and hold the second part 172 at multiple spaced apart gripping locations, and then the parts 170, 172 can be joined, such as by installation of one or more fasteners (e.g. clips) or with multiple spot welds 182 provided by a tooling device set up with a welder, as set forth herein.

FIG. 16 shows part of a tooling device 184 having a base 185 with a main body 186. Two tooling units 187 and 188, such as those described above with regard to FIGS. 6-12, are connected to the main body 186. In the implementation shown, tooling unit 187 is connected to a movable support or arm 189 that is coupled to the main body 186 to permit movement of tooling unit 187 relative to the tooling unit 188 and the main body 186. The arm 189 may be driven along the main body 186 by a suitable actuator, such as an electric motor. To facilitate connecting the tooling unit 187 to the base 185, the arm 189 includes a mounting bracket 190. The mounting bracket 190 is defined by two bracket member, shown as plates 191, having inner surfaces that are spaced apart and oriented parallel to the direction of movement of the arm 189 along the main body 186. The plates 191 engage a frame or main body 192 of the tooling unit 187 and hold the tooling unit 187 against lateral movement perpendicular to the direction of movement of the arm 189 along the main body 186. The mounting bracket 190 may include a cross member 193 that extends between the two plates 191 and is arranged to engage an adjacent portion of the tooling unit main body 192 to inhibit or prevent vertical movement or tipping/rotation of the tooling unit 187 relative to the mounting bracket 190, or the tooling unit main body 192 may engage part of the base main body 186 or other member to restrain or prevent vertical movement of the tooling unit 187.

To facilitate quick and automated connection and disconnection of the tooling unit 187 to and from the base 185, a base coupler 194 is fixed to the mounting bracket 190, and the tooling unit 187 includes a tooling unit coupler 195. In the implementation shown, the tooling unit coupler 195 is fixed to a rear surface of the main body 192 and is arranged to be connected to the base coupler 194 by slidable relative movement of the base 185 relative to the tooling unit 187 until the couplers 194 and 195 are in contact and become engaged. When engaged, the tooling unit main body 192 is received in the bracket 190 and is closely held between the plates 191 and cross member 193.

The tool 196 of tooling unit 187 is connected to the main body 192 by an attachment feature 197. In the example shown, the tool 196 is a welder of a welding tooling unit. The other tooling unit 188 may include a tool 198 that is a weld back plate arranged opposite to the welder 196. The tooling unit 188 may be connected to the base 185 by a mounting bracket 199 that may be arranged similarly to the mounting bracket 190, including suitable couplers on the bracket and frame/body of the tooling unit 188. The fit of the bracket 190 relative to the frame 192 and the connection of the couplers resists movement, including twisting or skewing of the tooling unit 187 relative to the base 185 during use of the tooling device, including under the forces of welding or punching or other tooling operations that may be performed by suitable tooling units used with the tooling device 184. Other arrangements of tooling devices including quick couplers and tooling unit retaining arrangements are shown in FIGS. 17-21.

FIG. 17 shows part of a tooling device 200 having a base 202 with a main body 204 and a movable arm 206 that is coupled to the main body 204 for slidable movement of the arm 206 relative to the main body 204. The arm 206 is connected to and driven relative to the main body 204 of the base 202 by an actuator 208. To facilitate connecting tooling units 210 to the base 202, the arm 206 includes a mounting bracket 212 at least a portion of which extends longitudinally outward away from the arm 206, in a direction parallel to the movement of the arm 206 relative to the main body 204 and toward an oppositely arranged second tooling unit (not shown) carried by the base 202 (or by a second movable arm, arranged opposite to the first movable arm 206). A base coupler 214 is fixed to the mounting bracket 212 at a location spaced from the arm 206.

In the implementation shown, the tooling unit coupler 222 is fixed to a lower surface of the main body 220 and is arranged to be connected to the base coupler 214 to secure the tooling unit 210 to the base 202 (via the bracket 212 and arm 206). The tool 218 is connected to the main body 220 of the support member 216 by an attachment feature 224. In the example shown, the tool 218 is a punch portion of a punch and die tooling device.

The tooling unit 210 includes a support member 216 to which a tool 218 is connected, generally as set forth with regard to the embodiment shown in FIGS. 6-12 and as otherwise described herein. The support member 216 includes a main body 220 and a tooling unit coupler 222 that is fixed to the main body 220. In the implementation shown, the tooling unit coupler 222 is fixed to a lower surface of the main body 220 and is arranged to be connected to the base coupler 214 to secure the tooling unit 210 to the base 202 (via the bracket 212 and arm 206). The tool 218 is connected to the main body 220 of the support member 216 by an attachment feature 224. In the example shown, the tool 218 is a punch portion of a punch and die tooling device. As in other embodiments already described, the die portion of the tooling device is carried by the second tooling unit that also is coupled to the base 202, and which may be coupled to a second movable arm or to a non-movable portion of the base 202, as desired. As before, the tooling device 200 may define a type of C-frame tooling device, which modular tooling units 210.

As shown in FIG. 17, when the tooling unit 210 is connected to the base 202, the tooling unit coupler 222 overlaps the base coupler 214 in a second direction, which is the vertical direction in the orientation shown in FIG. 17, and that is transverse to the movement of the arm 206 relative to the main body 204 of the base 202. Further, a line of force 226 on the support member 216 that occurs in use of the tool 218, extends from the attachment feature 224 and intersects both the tooling unit coupler 222 and the base coupler 214, such that the coupling is aligned with and resists the force in use of the tool 218. This alignment helps to reduce tilting of the tooling unit 210 relative to the arm 206 which would increase the tolerances needed in operation of the device 200, and reduce an accuracy of the tool 218 in use.

Further, the base 202 may include a retainer 230 that overlaps and engages a surface of the main body 220 of the support member 216 to further inhibit or prevent movement of the tooling unit 210 relative to the base 202 in use of the tool 218. The retainer 230 may include a channel 232 and the main body 220 may include a rail or flange 234 arranged to be closed received in the channel 232. The close fit between the flange 234 and the retainer 232 inhibits or prevents twisting or lateral movement (i.e. movement in a third direction or along a third axis that is transverse to the longitudinal direction or axis (e.g. longitudinal movement directions of the arm 206 relative to the main body 204 of the base 202) and also perpendicular to the second axis which may be called a vertical axis, where the movable arm 206 extends vertically from the main body 204 of the base 202 in at least some implementations. The retainer 230 also inhibits or prevents tipping of the support member 216 about the tooling unit coupler 222, and generally along a plane extending longitudinally and vertically, such as tends to occur due to the tooling 218 and line of force 226 in use of the tooling 218 being spaced from the movable arm 206 on which the tooling unit 210 is mounted.

In at least some implementations, the retainer channel 232 is oriented longitudinally, a centerline 236 of the connected couplers 214, 222 and channel 232 are also oriented along the first or longitudinal axis. Further, the retainer 230 is spaced from the couplers 214, 222 both vertically and longitudinally such that the retainer 230 and coupler 222 provide spaced apart and longitudinally aligned areas of connection between the support member 216 and the base 202 (e.g. the movable arm 206 and the bracket 212 of the base). Also in at least some implementations, the tool 218 (e.g. punch portion in this example) is coupled to the support member 216, such that the line of force 226 is applied to the support member 216 along the longitudinal axis in use of the tool 218. In at least some implementations, the main body 220 of the support member 216 includes two laterally spaced apart and parallel walls 238, and the tool 218 is received between the walls 238 and is coupled to the walls 238 by the attachment feature 224. In this way, the tool 218 may be longitudinally and laterally aligned with the couplers 214, 222, and oriented vertically spaced from the couplers.

To connect the tooling unit 210 to the base 202, the tooling unit 210 may be vertically and laterally aligned, and longitudinally forward and offset from the base coupler 214. The tooling unit 210 may be slid along the longitudinal axis/centerline 236 and toward the arm 206 until the tooling unit coupler 222 connects to the base coupler 214 and the flange 234 of the support member 216 is received at least partly in the channel 232 of the retainer 230. In at least some implementations, the multiple points of connection between the support member 216 and the base 202 enables a very rigid and secure connection of the tooling unit 210 to the base 202. Further, the line of force 226 in use of the tool 218 can be centered on the couplers 214, 222 and aligned with the retainer channel 232 to reduce any twisting or skewing or tipping of the tooling unit 210 in use. This enables the tooling unit 210 to achieve tight tolerances in use so the tooling device 200 can accurately and repeatedly perform work on parts. Tight tolerances can be important in may processes, with punching being one example in which the punch die and punch portion are closely matched in size and must be accurately aligned throughout the punching stroke and while under loads that occur during punching. Still further, connecting the tooling unit 210 to the base 202, and disconnecting the tooling unit 210 from the base 202, can be done automatically (e.g. by a robot 18). In at least some implementations, neither the retainer 230 nor the couplers 214, 222 require fasteners or other retention mechanisms to be used, and connecting and disconnecting of the tooling unit 210 can occur with simple movement of the tooling unit 210 relative to the base 202 (e.g. relative to the base coupler 214 and retainer 230).

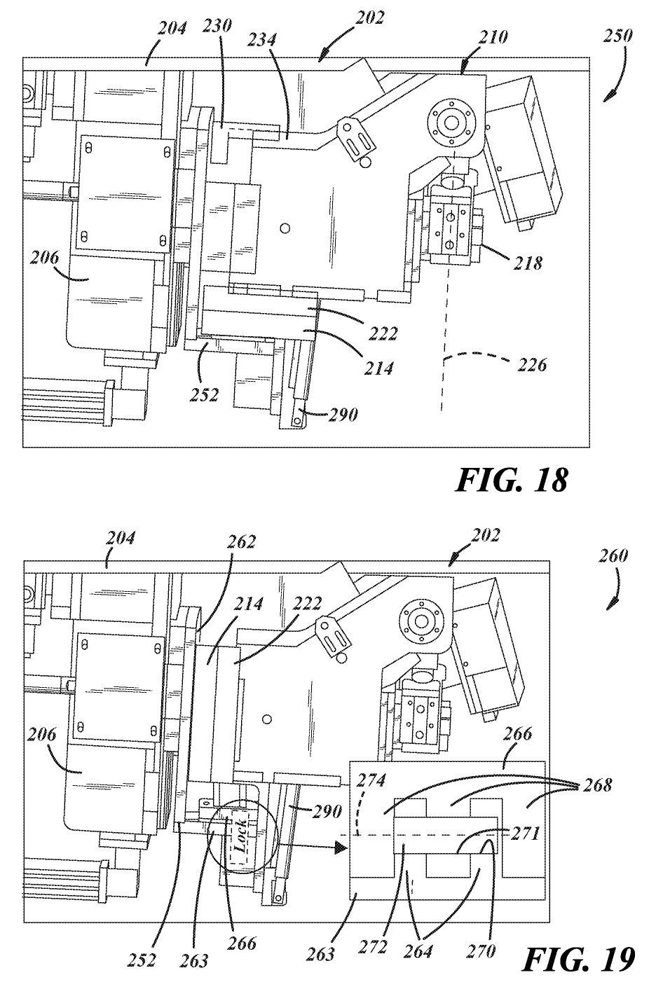

In FIG. 18, wherein like numbers indicate like parts described in greater detail with regard to FIG. 17 and incorporated herein, an example of a tooling device 250 is shown. This tooling device 250 may include the same base 202 with the main body 204 and arm 206 as already described. In this example, the bracket 252 extending outwardly from the movable arm 206 is longitudinally shorter, and the base coupler 214 and tooling unit coupler 222 are connected to each other at a location closer to the movable arm 206 than in the implementation shown in FIG. 17. The retainer 232 is coupled to the movable arm 206 at a location vertically above the base coupler 214 as in the embodiment of FIG. 17, but in this tooling device 250, the retainer 230 overlaps the first support member flange 234 at a location that is laterally aligned with the couplers 214, 222 and that overlies the couplers 214, 222 longitudinally and vertically.

Also in this example, the tool 218 is connected to the support member 216 at a location that is vertically and longitudinally spaced from the couplers 214, 222, and the line of force 226 is then longitudinally spaced from the couplers 214, 222. Without the retainer 230 engaging the flange 234, the longitudinal separation between the tool 218 and the couplers 214, 222, and the resulting offset of the line of force 226 from the couplers, would tend to cause the tooling unit 210 to tip forward relative to the movable arm 206. But this movement is resisted and minimized or eliminated by the engagement of the flange 234 with the retainer 230, and also by the couplers 214, 222 that are connected together and resist being decoupled by forces along the second, vertical axis and instead require longitudinal relative movement for disconnection. As in the prior example, the tooling unit 210 can be automatically connected to and disconnected from the base 202, by movement of the tooling unit 210 along the longitudinal direction and relative to the movable arm 206, until the couplers 214, 222 are connected and the flange 234 is received in the retainer channel 232. The shorter bracket 252 on the movable arm 206 can, among other things, make coupling and decoupling of the tooling unit 210 easier and provide a less bulky and lighter weight tooling device 250.

In FIG. 19, wherein like numbers indicate like parts described in greater detail with regard to one or both of FIGS. 17 and 18, and incorporated herein, a further example of a tooling device 260 is shown. In this example, the base 202 including the main body 204 and arm 206 may be as described with regard to the tooling device 200, and a bracket 252 as described with the tooling device 250 may be coupled to the arm 206. In this example, the base coupler 214 is connected to the bracket 252 or the arm 206 along a vertically extending surface 262, rather than a longitudinally extending flange as in the embodiments of FIGS. 17 and 18. The interface surface of the base coupler 214 is then oriented vertically, along the second axis, instead of horizontally/longitudinally. The bracket has a longitudinal flange 263 that extends longitudinally from the movable arm 206 and includes one or more fingers 264 that are spaced apart laterally, extend vertically upward and that may be spaced longitudinally from and not longitudinally overlapped by the base coupler 214. The tooling unit 260 includes a support member 266 that has one or more corresponding fingers 268 arranged to be received laterally adjacent to the one or more fingers 264 of the base. In at least some implementations, multiple fingers 268 of the support member 266 are arranged to be adjacent to and interleaved with multiple fingers 264 of the base 202, preferably with a close, line to line fit between the fingers 264, 268 to reduce or eliminate gaps and “play” between them.

Further, laterally extending openings 270, 271 are provided in at least some of the fingers 264, 268 of both the support member 266 and the base 202, and the openings 270, 271 are aligned when the tooling unit 260 is mounted to the base 202. The openings 270, 271 are adapted to receive one or more pins 272 with each pin 272 overlapping at least one finger 264 of the base 202 and at least one finger 268 of the first support member 266. When received in the openings 270, 271, the pin or pins 272 restrain movement of the support member 266 relative to the base 202 both longitudinally and vertically. Further, the overlapped fingers 264, 268 inhibit or prevent relative lateral movement between the base 202 and support member 266. In this way, the pins 272 may define a pivot axis 274 that extends laterally, and in the absence of the connection between the couplers 214, 222, the pins 272 and fingers 264, 268 would permit only pivoted movement of the tooling unit 260 relative to the base 202. Such pivoted movement, however, is prevented by the couplers 214, 222 which are connected together when the tooling unit 260 is mounted to the base 202.

During connection to and disconnection of the tooling unit 260 relative to the base 202, the tooling unit 260 may be moved along the second axis (i.e. vertically) relative to the movable arm 206, until the couplers 214, 222 become connected and the fingers 268 of the first support member 266 are received adjacent to and interleaved with the fingers 264 of the base 202. Thereafter, the pin or pins 272 can be inserted into the aligned openings 270, 271 of the interleaved fingers to complete the connection between the tooling unit 260 and base 202.

While the physical, mechanical connections have been described above, the tooling units may also require electrical connection to the base and a robot 18 to which a base is connected. The electrical connections may be made by way of one or more electrical connectors 290 (examples shown in FIGS. 17-19) that may mate with complementary connector(s) of the base 202 (e.g. male and female, plug and socket). The connectors can be coupled during the motion by which the tooling units are connected to the base 202, or manually connected, as desired. The electrical connections may provide electrical power to actuators that drive the tools of the tooling units, to power cameras or sensors carried by the tooling units, to generate heat or other action for welding, and the like, as well as to permit data communication from sensors on the tooling units.

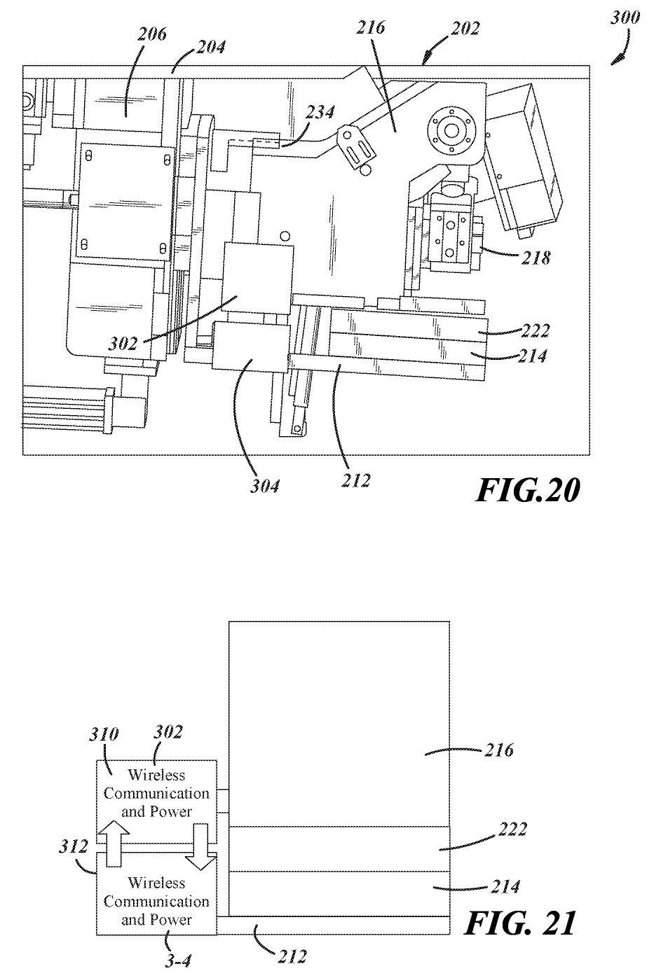

In the example shown in FIGS. 20 and 21, the tooling unit 300 may be used with any desired base of a tooling device. In the example shown, the base 202 is as described with reference to FIG. 17, including the main body 204, arm 206 and bracket 212. This tooling unit 300 includes a wireless power and communication module 302 (hereafter, called the tooling unit module) and the base 202 includes a complementary wireless power and communication module 304 (hereafter called the base module). The base module 304 may wirelessly provide electrical power (e.g. via electromagnetic fields) to the tooling unit module 302, which may include a battery 306 that is charged by the power it receives from the base module 304. The battery power can then be used to power the electrical components of the tooling unit 300. Similarly, the modules 302, 304 may include data communication devices (e.g. transmitters, receivers or both) to permit desired communication between the tooling unit 300 and the base202 and robot 18 to which the base 202 is connected.

In the example shown, the base module 304 is carried by or connected to the bracket 212 on which the base coupler 214 is fixed. The tooling unit module 302 is arranged on the support member 216 so that the modules 302, 304 are adjacent to each other and are close enough together to permit the desired transmissions between them. In at least some implementations, housings 310, 312 of the modules 302, 304 may contact each other when the tooling unit 300 is mounted on the base 202, and in other implementations, the modules 302, 304 may be spaced apart from each other without direct contact between them. The modules 302, 304 may utilize any desired wireless power and data transmission systems/protocols, such as but not limited to, inductive coupling, capacitive coupling, power beaming, NFC Wireless UART, Qi Data over Wireless Power, Simultaneous Wireless Information and Power Transfer (SWIPT), and Information Harvesting. The wireless transmissions facilitate use of the tooling devices in that electrical connectors do not need to be reliably and securely connected, excess cabling is not needed to permit movement of the arm/tooling unit relative to the base, and the arm/tooling units can readily be moved relative to the main body of the base without interference from cables or connectors, and without the possibility of electrical disconnection (so long as the tooling unit remains connected to the base). Further, a wide range of power and data protocols and requirements can be accommodated.

The flexible part processing systems enable machining or joining operations in an open space system wherein a fixture for a part is not necessarily a reliable datum for part location, and wherein the part may be used in its location in space as the relevant datum point for the operations to be performed. Different parts (e.g. not just different ones of the same exact model or part design, but different parts of different designs) can be worked on with the same tooling and in the same production lines or work areas, with part position sensing and robots responsive to actual part positions and capable of manipulating tooling to match the determined part locations, and at different locations for the different parts. Further, to facilitate performing different operations in the same work area, flexible and adaptable tooling systems have been developed that, for example, permit a robot to perform a variety of operations on a part by equipping itself with different tooling or tooling modules, at different times.

In at least some implementations, the flexible processing systems do not require human intervention. Instead, parts can be moved into and out of one or more work areas by a suitable conveying device or system, the location of the parts within a work area can be determined by sensing devices and a vision system, and the robots are effective to perform desired work on the parts, including changing tooling as needed, and bringing secondary parts (e.g. brackets) to the fixtured parts, and coupling the secondary parts to the fixtured parts. The automated work area can also automatically perform work on different designs of parts in the same work session, as the different parts can be recognized by the vision system and the robots can then be commanded by the control system to perform the needed work on the parts within the work area.

The forms of the innovations herein disclosed constitute presently preferred embodiments and many other forms and embodiments are possible. It is not intended herein to mention all the possible equivalent forms or ramifications of the innovations. It is understood that the terms used herein are merely descriptive, rather than limiting, and that various changes may be made without departing from the spirit or scope of the present disclosure.

All terms used in the claims are intended to be given their broadest reasonable construction and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

1. A method of performing work on a part with one or more tools, comprising:
providing a part on a fixture within a workstation, wherein one or both of the location of the part on the fixture or the location of the fixture in the workstation is variable from one part to the next, and wherein the part includes at least one position identification feature on a surface of the part;
determining a location of the part in the workstation with a position sensing device that detects the location and orientation of the at least one position identification feature;
positioning a tool relative to the part as a function of the determined location of the part; and
performing a work process on the part with the tool.

2. The method of claim 1 wherein the variability in one or both of the location of the part on the fixture or the location of the fixture in the workstation is greater than a maximum tolerance of the work process.

3. The method of claim 1 wherein the at least one position identification feature includes at least one marking on a surface of the product.

4. The method of claim 1 wherein the at least one position identification feature is defined by one or more scribe lines, or molded-in projections or cavities formed in the part.

5. The method of claim 1 wherein the at least one position identification feature includes at least one location identifying feature by which the location of a specific portion of the part can be determined, and the at least one position identification feature includes at least one direction identifying feature by which an orientation of the part can be determined.

6. The method of claim 1 wherein the tool is carried by a robot and the position sensing device is carried by the robot and is movable by the robot.

7. The method of claim 6 wherein the position sensing device is a camera, and the camera is carried by the robot so that a field of view of the camera includes at least a portion of the tool and an area in which the part is located.

8. The method of claim 6 wherein the tool is a first tool and the method also includes changing the tool to a second tool and performing a second work process on the part via the robot with the second tool.

9. The method of claim 8 wherein the first tool includes a first coupler that connects to an end effector of the robot, the second tool includes a second coupler that connects to an end effector of the robot, and wherein the robot is adapted to automatically disconnect from the first tool and connect to the second tool to perform the second work process with the second tool.

10. The method of claim 8 wherein the first tool and the second tool are part of separate C-frame assemblies, and changing the tool is accomplished by changing from a first C-frame assembly that includes the first tool to a second C-frame assembly that includes the second tool.

11. The method of claim 8 wherein the first tool and the second tool are part of separate tooling units that are releasably connected to a base, and changing the tool is accomplished by disconnecting from the base a first tooling unit that includes the first tool and connecting to the base a second tooling unit that includes the second tool.

12. A system by which one or more work processes are performed on a part, comprising:
a fixture having a support;
a part received on the fixture engaging the support, wherein the fixture permits the part to be located in different positions on the fixture;
a robot having a connector and a vision sensor; and
a tool coupled to the robot via the connector so that the tool is movable by the robot and a position of the tool can be determined with the vision sensor, wherein the part includes at least one position identification feature by which a location and orientation of the part can be determined, and wherein the vision sensor is arranged to determine the location and orientation of the position identification feature.

13. The system of claim 12 wherein the at least one position identification feature includes at least one marking on a surface of the product, or one or more scribe lines, or one or more molded-in projections or one or more cavities formed in the part.

14. The system of claim 12 wherein the at least one position identification feature includes at least one location identifying feature by which the location of a specific portion of the part can be determined, and the at least one position identification feature includes at least one direction identifying feature by which an orientation of the part can be determined.

15. The system of claim 12 wherein the position sensing device is a camera, and the camera is carried by the robot so that a field of view of the camera includes at least a portion of the tool and an area in which the part is located.

16. The system of claim 12 wherein the tool is a first tool and wherein the system also includes a second tool that is releasably connectable to the connector, and wherein the robot is adapted to automatically disconnect from the first tool and connect to the second tool and to perform a work process on the part with the second tool.

17. The system of claim 16 wherein the first tool and the second tool are part of separate C-frame assemblies, and the robot is adapted to automatically disconnect from one C-frame assembly and connect to another C-frame assembly to provide a selected one of the first tool or the second tool on the robot.

18. The system of claim 16 wherein the first tool and the second tool are part of separate tooling units that are releasably connected to a base, the base is connected to the robot, and changing the tool is accomplished by disconnecting from the base a first tooling unit that includes the first tool and connecting to the base a second tooling unit that includes the second tool.

19. The system of claim 12 which also includes a second position sensing device arranged to enable determination of the position of the fixture and part within a workstation that includes the robot.

20. The system of claim 14 wherein the location identifying feature includes a circle the center of which is located at the center of a location in which an opening is to be formed in the part, and wherein the orientation identifying feature includes a non-circular feature.
